(19) United States
(12) Patent Application Publication
(10) Pub. No.: US 2026/0135507 A1
(43) Pub. Date: May 14, 2026

(54) MOTOR CONTROL SYSTEM AND CONTROL METHOD

(71) Applicant: Hyundai Wia Corporation, Changwon (KR)

(72) Inventors: Hyun Woo Lee, Changwon (KR); Dae Kwan Koo, Changwon (KR); Jin Woo Choi, Changwon (KR); Seung Hun Choi, Changwon (KR); Heon Kang, Changwon (KR)

(21) Appl. No.: 19/387,279

(22) Filed: Nov. 12, 2025

(30) Foreign Application Priority Data
Nov. 13, 2024 (KR) 10-2024-0161229
Apr. 8, 2025 (KR) 10-2025-0045677

(51) Int. Cl. H02P 29/50

(52) U.S. Cl. CPC H02P 29/50

(57) ABSTRACT

A motor control system and method are introduced, comprising an estimation unit configured to estimate an angular velocity of a motor in real time, a filter unit having at least one of a torque command and the angular velocity of the motor as an input signal and configured to extract a pulsation component corresponding to a reference frequency from the input signal and adjust the reference frequency based on the angular velocity estimated in real time, and a control unit configured to perform damping control to reduce the pulsation component.

### CROSS-REFERENCE TO RELATED APPLICATION

This application claims, under 35 U.S.C. § 119(a), the benefit of Korean Patent Application No. 10-2024-0161229, filed Nov. 13, 2024, and Korean Patent Application No. 10-2025-0045677, filed Apr. 8, 2025, in the Korean Intellectual Property Office, the entire contents of which are incorporated herein by reference.

### BACKGROUND

### (a) Technical Field

The present disclosure relates to a motor control system and a control method configured to dampen vibration of a motor.

### (b) Background

An electric compressor applied to a thermal management system of an automobile repeats suction, compression, and circulation every time the compressor rotates once per mechanical angle cycle and, at this time, a pulsation component of a load torque generated while a scroll of the compressor rotates causes a speed pulsation component. Such a pulsation component may affect drive stability in a low-speed drive region of the motor and may affect durability in a high-speed drive region.

In addition, a sensorless algorithm is widely applied to electric compressors, and speed pulsation and torque ripple during such sensorless control may generate an error in position information of the rotor and affect performance of the system.

Therefore, in driving the motor, there is a need to propose a method capable of improving control stability at low-speed and durability at high-speed by reducing the pulsation component.

The matters described as the background art above are for the purpose of enhancing understanding of the background of the present disclosure, and should not be accepted as an acknowledgment that they correspond to conventional technology already known to a person having ordinary skill in the technical field.

### SUMMARY

An object of the present disclosure is to provide a motor control system and a control method capable of improving performance of motor driving by dampening vibration of the motor.

The problem of the present disclosure is not limited to the problem mentioned above, and another problem not mentioned will be clearly understood by a person skilled in the art from the following description.

A motor control system according to an embodiment of the present disclosure for realizing the above-described problem comprises an estimation unit configured to estimate an angular velocity of a motor in real time based on a phase current and a voltage command of the motor, a filter unit having at least one of a torque command and the angular velocity of the motor as an input signal and configured to extract a pulsation component corresponding to a reference frequency from the input signal and adjust the reference frequency based on the angular velocity estimated in real time, and a control unit configured to perform damping control to reduce the extracted pulsation component by controlling the motor based on the extracted pulsation component.

A motor control method according to an embodiment of the present disclosure for realizing the above-described problem comprises estimating an angular velocity of a motor in real time based on a phase current and a voltage command of the motor, extracting a pulsation component corresponding to a reference frequency from an input signal, the input signal having at least one of a torque command and the angular velocity of the motor, and performing damping control to reduce the extracted pulsation component by controlling the motor based on the extracted pulsation component, wherein the extracting comprises adjusting the reference frequency based on the angular velocity estimated in real time.

According to various embodiments of the present disclosure as described above, performance of extracting the pulsation component of the motor may be improved through an adaptive filter structure, and control stability and durability of the motor may be improved by performing damping control based on the extracted pulsation component.

According to an aspect of the present disclosure, a motor control system is provided. The motor control system may comprise a computing device, comprising a processor and memory. The computing device may be configured to estimate an angular velocity of a motor in real time based on a phase current and a voltage command of the motor, using at least one of a torque command and the angular velocity of the motor as an input signal, extract a pulsation component corresponding to a reference frequency from the input signal, adjust the reference frequency based on the angular velocity estimated in real time, and perform damping control to reduce the extracted pulsation component by controlling the motor based on the extracted pulsation component.

According to an exemplary embodiment, the computing device may be configured to extract an output signal having an identical phase to the input signal and having a frequency corresponding to the reference frequency as the pulsation component.

According to an exemplary embodiment, the computing device may be configured to generate a delayed signal having a phase delayed by 90 degrees from the input signal and feedback control the output signal based on the delayed signal.

According to an exemplary embodiment, the computing device may be configured to feedback control the output signal based on an error signal obtained by applying a predetermined proportional constant to an error between the input signal and the output signal.

According to an exemplary embodiment, the predetermined proportional constant may be variable based on the angular velocity, and may be predetermined to have a positive correlation with the angular velocity.

According to an exemplary embodiment, the computing device may be configured to perform the damping control based on a compensated torque command obtained by removing the extracted pulsation component from the torque command, when the input signal is the torque command.

According to an exemplary embodiment, the computing device may be configured to perform the damping control based on a compensated angular velocity obtained by removing the extracted pulsation component from the angular velocity, when the input signal is the angular velocity.

According to an exemplary embodiment, the computing device may be configured to extract the pulsation component from the torque command or extract the pulsation component from the angular velocity based on a magnitude of the angular velocity.

According to an exemplary embodiment, the computing device may be configured to extract the pulsation component from the angular velocity when the angular velocity is equal to or less than a predetermined reference speed and extract the pulsation component from the torque command when the angular velocity exceeds the reference speed.

According to an exemplary embodiment, the computing device may be configured to perform the damping control based on a compensated angular velocity obtained by removing the extracted pulsation component from the angular velocity when the angular velocity is equal to or less than the reference speed and perform the damping control based on a compensated torque command obtained by removing the extracted pulsation component from the torque command when the angular velocity exceeds the reference speed.

According to an aspect of the present disclosure, a motor control method is provided. The motor control method may comprise, using a computing device, estimating an angular velocity of a motor, in real time, based on a phase current and a voltage command of the motor, and extracting a pulsation component corresponding to a reference frequency from an input signal. The input signal may comprise at least one of a torque command and the angular velocity of the motor. The motor control method may comprise performing damping control to reduce the extracted pulsation component by controlling the motor based on the extracted pulsation component. The extracting may comprise adjusting the reference frequency based on the angular velocity estimated in real time.

According to an exemplary embodiment, the extracting may comprise extracting an output signal having an identical phase to the input signal and a frequency corresponding to the reference frequency as the pulsation component.

According to an exemplary embodiment, the extracting may comprise generating a delayed signal having a phase delayed by 90 degrees from the input signal and feedback controlling the output signal based on the delayed signal.

According to an exemplary embodiment, the extracting may comprise feedback controlling the output signal based on an error signal obtained by applying a predetermined proportional constant to an error between the input signal and the output signal.

According to an exemplary embodiment, the predetermined proportional constant may be variable based on the angular velocity and is predetermined to have a positive correlation with the angular velocity.

According to an exemplary embodiment, the performing the damping control may comprise performing the damping control based on a compensated torque command obtained by removing the extracted pulsation component from the torque command, when the input signal is the torque command.

According to an exemplary embodiment, the performing the damping control may comprise performing the damping control based on a compensated angular velocity obtained by removing the extracted pulsation component from the angular velocity, when the input signal is the angular velocity.

According to an exemplary embodiment, the extracting may comprise extracting the pulsation component from the torque command, or extracting the pulsation component from the angular velocity based on a magnitude of the angular velocity.

According to an exemplary embodiment, the extracting may comprise extracting the pulsation component from the angular velocity when the angular velocity is equal to or less than a predetermined reference speed and extracting the pulsation component from the torque command when the angular velocity exceeds the reference speed.

According to an exemplary embodiment, the performing the damping control may comprise performing the damping control based on a compensated angular velocity obtained by removing the extracted pulsation component from the angular velocity, when the angular velocity is equal to or less than the reference speed and performing the damping control based on a compensated torque command obtained by removing the extracted pulsation component from the torque command, when the angular velocity exceeds the reference speed.

Effects obtainable from the present disclosure are not limited to the effects mentioned above, and another effect not mentioned will be clearly understood by a person having ordinary skill in the technical field to which the present disclosure pertains from the following description.

### BRIEF DESCRIPTION OF THE DRAWINGS

The foregoing and other aspects, features, and advantages, as well as the following detailed description of the embodiments, will be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 illustrates a view showing a motor drive system to which a motor control system is applied, according to an exemplary embodiment of the present disclosure.

FIG. 2 illustrates a view showing a structure of an estimation unit, according to an exemplary embodiment of the present disclosure.

FIG. 3 illustrates a view showing a structure of a filter unit, according to an exemplary embodiment of the present disclosure.

FIGS. 4 and 5 are views illustrating Bode diagrams of a filter unit, according to an exemplary embodiment of the present disclosure.

FIGS. 6 and 7 are views illustrating a structure of a control unit, according to an exemplary embodiment of the present disclosure.

FIG. 8 illustrates a flowchart for explaining a motor control method, according to an exemplary embodiment of the present disclosure.

FIG. 9 illustrates a view for explaining an effect of damping control, according to an exemplary embodiment of the present disclosure.

FIG. 10 illustrates example elements of a computing device, according to an exemplary embodiment of the present disclosure.

### DETAILED DESCRIPTION

Specific structural or functional descriptions of the embodiments of the present disclosure disclosed in the present specification or application are illustrated only for the purpose of explaining the embodiments according to the present disclosure, and the embodiments according to the present disclosure may be implemented in various forms and should not be construed as being limited to the embodiments described in the present specification or application.

Since the embodiments according to the present disclosure can apply various changes and can have various forms, specific embodiments are illustrated in the drawings and described in detail in the present specification or application. However, this is not intended to limit the embodiments according to the concept of the present disclosure to a specific disclosed form, and should be understood to include all modifications, equivalents, or substitutes included in the spirit and technical scope of the present disclosure.

Unless otherwise defined, all terms used herein, including technical or scientific terms, have the same meaning as commonly understood by a person having ordinary skill in the technical field to which the present disclosure pertains. Terms such as those defined in commonly used dictionaries should be construed as having meanings consistent with the meanings in the context of the related art, and are not construed in an ideal or excessively formal sense unless explicitly defined in the present specification.

Hereinafter, the embodiments disclosed in the present specification will be described in detail with reference to the accompanying drawings, and the same or similar components are assigned the same reference numbers regardless of the drawing symbols, and redundant descriptions thereof will be omitted.

In the description of the following embodiments, the term “predetermined” means that the numerical value of a parameter is determined in advance when the parameter is used in a process or algorithm. According to an embodiment, the numerical value of the parameter may be set when the process or algorithm starts, or may be set during a section in which the process or algorithm is performed.

The suffixes “module” and “unit” for components used in the following description are given or used interchangeably only considering ease of writing the specification, and do not have meanings or roles that are distinguished from each other.

In describing the embodiments disclosed in the present specification, detailed descriptions of related known technologies are omitted when it is determined that they may obscure the subject matter of the embodiments disclosed in the present specification. In addition, the accompanying drawings are only for easily understanding the embodiments disclosed in the present specification, and the technical ideas disclosed in the present specification are not limited by the accompanying drawings, and should be understood to include all modifications, equivalents, or substitutes included in the spirit and technical scope of the present disclosure.

Terms including ordinal numbers such as first and second may be used to describe various components, but the components are not limited by the terms. The terms are used only for the purpose of distinguishing one component from another component.

When a component is referred to as being “connected to” or “in contact with” another component, it should be understood that the other component may be directly connected to or in contact with the other component, but other components may exist in between. On the other hand, when a component is referred to as being “directly connected to” or “directly in contact with” another component, it should be understood that no other components exist in between.

Singular expressions include plural expressions unless the context clearly dictates otherwise.

In the present specification, terms such as “comprising” or “having” are intended to designate that features, numbers, steps, operations, components, parts, or combinations thereof described in the specification exist, and should be understood as not excluding in advance the existence or possibility of addition of one or more other features, numbers, steps, operations, components, parts, or combinations thereof.

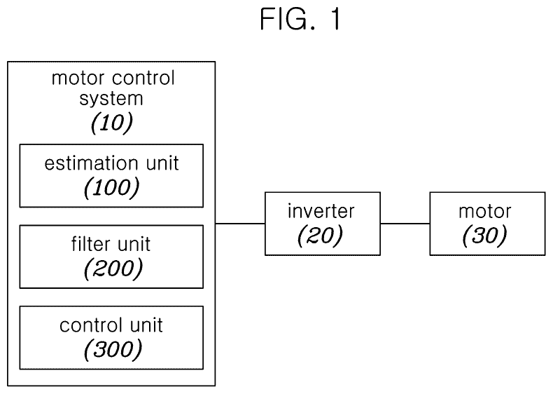

Hereinafter, prior to describing a motor control method, according to an exemplary embodiment of the present disclosure, a motor control system, according to an exemplary embodiment, will first be described with reference to FIGS. 1 to 7.

FIG. 1 illustrates a view showing a motor drive system to which a motor control system is applied, according to an exemplary embodiment of the present disclosure.

Referring to FIG. 1, a motor control system 10, according to an exemplary embodiment, is applied to a motor drive system that is configured to drive a motor 30 via an inverter 20, and may be configured to control driving of the motor 30 via the inverter 20.

To the present end, the motor control system 10 may comprise a communication device that is configured to communicate with other controllers or sensors, a memory that is configured to store operating systems, logic commands, input/output information, and the like, and one or more processors that are configured to perform judgments, calculations, decisions, and the like necessary for controlling assigned functions, and may be implemented, for example, as a motor control unit (MCU).

Here, a unit or control unit included in names such as motor control unit (MCU) is only a term widely used in naming a controller that controls a specific function, and does not mean a generic function unit.

According to an exemplary embodiment, the motor 30 may comprise, for example, a drive motor of an electric compressor. During driving of the electric compressor, a vibration phenomenon of air may occur because of a pressure difference between a suction side and a discharge side of a scroll, and angular velocity pulsation may be caused, and such speed pulsation can be confirmed in a mechanical angular velocity of the motor 30. The motor control system, according to an exemplary embodiment, may be configured to use the present point to propose extracting a pulsation component based on the mechanical angular velocity of the motor 30 and performing damping control based on the extracted pulsation component.

More specifically, the motor control system 10 may comprise an estimation unit 100, a filter unit 200, and a control unit 300. However, FIG. 1 is illustrated for explaining an embodiment, and the actual motor control system 10 may comprise more or fewer components than the present, or may be implemented in a different form.

First, the estimation unit 100 may be configured to estimate an angular velocity of the motor 30 in real time based on a phase current and a voltage command of the motor 30. That is, in an embodiment, a sensor for detecting a rotor position of the motor 30 is not provided, and the angular velocity of the motor 30 may be estimated through a sensorless algorithm of the estimation unit 100, and the motor 30 may be controlled based on the estimated angular velocity.

The filter unit 200 may be configured to receive at least one of a torque command and the estimated angular velocity of the motor 30 as an input signal, and may be configured to extract a pulsation component corresponding to a reference frequency from the input signal. According to an exemplary embodiment, the filter unit 200 may be configured to adjust the reference frequency according to the angular velocity of the motor 30, and through the present, performance of extracting the pulsation component generated per mechanical angle cycle of the motor 30 may be improved.

The control unit 300 may be configured to perform damping control to reduce the extracted pulsation component by controlling the motor 30 based on the extracted pulsation component, and as a result of the damping control, control stability and durability of the motor 30 may be improved.

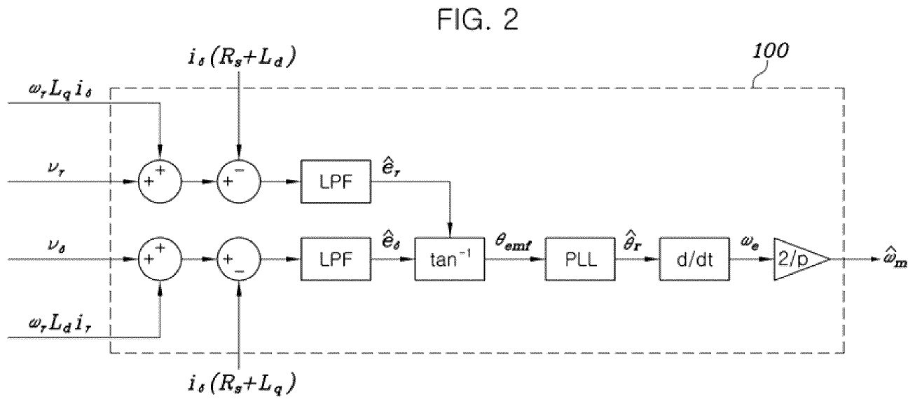

Hereinafter, each component of the motor control system 10 will be described in more detail with reference to FIGS. 2 to 7.

First, FIG. 2 illustrates a view showing a structure of an estimation unit, according to an exemplary embodiment of the present disclosure.

Referring to FIG. 2, the estimation unit 100, according to an exemplary embodiment, may be configured to estimate the angular velocity of the motor 30 through sensorless control based on an extended back EMF method.

More specifically, the estimation unit 100 may be configured to estimate extended back EMF (ê_{γ}, ê_{δ}) through voltage equations in a γ-δ coordinate system, and when estimating the extended back EMF (ê_{γ}, ê_{δ}), a low pass filter (LPF) may be utilized. In the present case, the voltage equations in the γ-δ coordinate system and the extended back EMF (ê_{γ}, ê_{δ}) may be expressed by the Equation 1, Equation 2, and Equation 3.

$$[ \begin{matrix}{v}_{γ} \\ {v}_{δ}\end{matrix} ] = [ \begin{matrix}{R}_{s} + ρ {L}_{d} & - {ω}_{r} {L}_{q} \\ {ω}_{r} {L}_{q} & {R}_{s} + ρ {L}_{d}\end{matrix} ] [ \begin{matrix}{i}_{γ} \\ {i}_{δ}\end{matrix} ] + [ \begin{matrix}{e}_{γ} \\ {e}_{δ}\end{matrix} ] \qquad Equation 1$$

$${e}_{γ} = {v}_{γ} + {ω}_{r} {L}_{q} {i}_{δ} - ( {R}_{s} + ρ {L}_{d} ) {i}_{γ} \qquad Equation 2$$

$${e}_{δ} = {v}_{δ} - {ω}_{r} {L}_{q} {i}_{δ} - ( {R}_{s} + ρ {L}_{d} ) {i}_{δ} \qquad Equation 3$$

Here, v_{γ}, v_{δ} are γ-axis, δ-axis voltage commands, Rₛ is stator resistance, L_{d}, L_{q} are d-q axis inductances, ρ is a time derivative operator, or is electrical angular velocity, and i_{γ}, i_{δ} are γ-axis, δ-axis currents.

The estimation unit 100 may be configured to estimate a rotor position (θ_{emf}) based on the extended back EMF (ê_{γ}, ê_{δ}), and may be configured to obtain an electrical angle (Or) of the rotor through a phase-locked loop (PLL). In the present case, in estimating the rotor position (θ_{emf}) based on the extended back EMF (ê_{γ}, ê_{δ}), Equation 4 and Equation 5 may be utilized.

$$[ \begin{matrix}{\hat{e}}_{γ} \\ {\hat{e}}_{δ}\end{matrix} ] = {E}_{emf} [ \begin{matrix}- sin {\hat{θ}}_{r} \\ cos {\hat{θ}}_{r}\end{matrix} ] \qquad Equation 4$$

$${θ}_{emf} = {tan}^{- 1} ( \frac{- {\hat{e}}_{γ}}{{\hat{e}}_{δ}} ) \qquad Equation 5$$

Here, E_{emf} means a magnitude of the back EMF.

When the electrical angle (\hat{θ}ᵣ) of the rotor is obtained as such, the estimation unit 100 may be configured to determine electrical angular velocity (ωₑ) by differentiating the electrical angle (\hat{θ}ᵣ), and may be configured to finally estimate mechanical angular velocity (\hat{ω}ₘ) by applying a number of poles (p) to the electrical angular velocity (ωₑ).

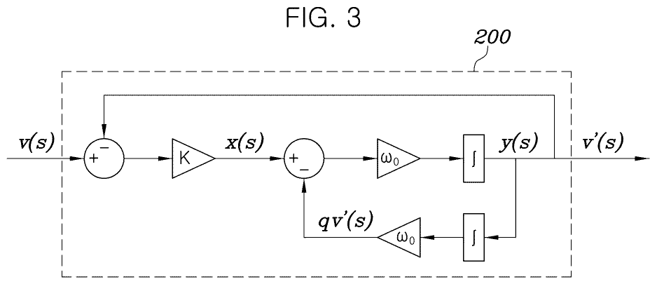

Hereinafter, extraction of the pulsation component through the filter unit 200 will be described with reference to FIG. 3.

FIG. 3 illustrates a view showing a structure of a filter unit, according to an exemplary embodiment of the present disclosure.

Referring to FIG. 3, the filter unit 200 may be implemented with a second order generalized integrators-quadrature signal generation (SOGI-QSG) structure, and may be expressed by the following transfer functions.

$$G ( s ) = \frac{y}{x} ( s ) = \frac{s {ω}_{0}}{{s}^{2} + {ω}_{0}^{2}} \qquad Equation 6$$

$$D ( s ) = \frac{{v}^{′}}{v} ( s ) = \frac{kG ( s )}{1 + kG ( s )} = \frac{ks {ω}_{0}}{{s}^{2} + ks {ω}_{0} + {ω}_{0}^{2}} \qquad Equation 7$$

$$Q ( s ) = \frac{{qv}^{′}}{v} ( s ) = \frac{{ω}_{0} D ( s )}{s} = \frac{k {ω}_{0}^{2}}{{s}^{2} + ks {ω}_{0} + {ω}_{0}^{2}} \qquad Equation 8$$

The transfer function G(s) has characteristics of a second order adaptive filter having two integrators, the transfer function D(s) has characteristics of a band pass filter (BPF), and the transfer function Q(s) has characteristics of a low pass filter (LPF).

Here, v(s) is an input signal, v′(s) is an output signal, x(s) is an error signal according to a difference between the input signal and the output signal, y(s) is an in-phase signal having an identical phase to the input signal, and qv′(s) is a delayed signal having a phase delayed by 90 degrees from the input signal. In addition, K is a bandwidth gain constant, and wo is a reference frequency that is a reference for frequency filtering.

According to an exemplary embodiment, the input signal v(s) may be at least one of a torque command and an angular velocity of the motor 30, and when the input signal v(s) is the torque command, a pulsation component of the torque command becomes the output signal v′(s), and when the input signal v(s) is the angular velocity, a pulsation component of the angular velocity can become the output signal v′(s).

Meanwhile, the filter unit 200 may be configured to extract only a pulsation component having a frequency corresponding to the angular velocity of the motor 30 by adjusting the reference frequency ω₀ according to the angular velocity. As the angular velocity for determining the reference frequency ω₀, the mechanical angular velocity estimated by the estimation unit 100 may be utilized, and accordingly, the filter unit 200 may be configured to pass only a frequency corresponding to the mechanical angular velocity of the motor 30 to minimize a delay component, and may extract only a pulsation component generated because of mechanical characteristics of the motor 30.

In addition, because of characteristics of the second order adaptive filter, the filter unit 200 may be configured to extract a signal having a specific phase as well as a specific frequency, and may finally extract the output signal v′(s) having an identical phase to the input signal v(s) and having a frequency corresponding to the reference frequency ω₀ as the pulsation component.

More specifically, the filter unit 200 may be configured to generate a delayed signal qv′(s) having a phase delayed by 90 degrees from the input signal v(s), and may extract the pulsation component having an identical phase to the input signal v(s) by feedback controlling the output signal v′(s) based on the delayed signal qv′(s).

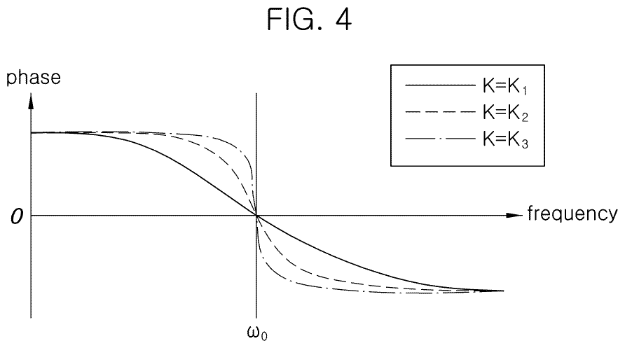

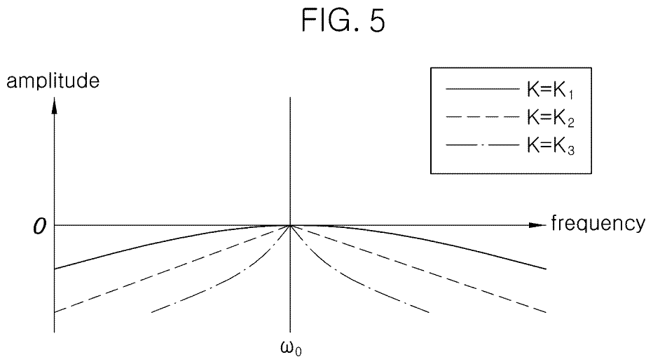

Meanwhile, the filter unit 200 may be configured to apply a bandwidth gain constant K to the input signal v(s) and the output signal v′(s). In the present case, the bandwidth gain constant K may be variable based on the angular velocity, and in particular, may be predetermined to have a positive correlation with the angular velocity. The present will be described with reference to FIGS. 4 and 5 below.

FIGS. 4 and 5 are views illustrating Bode diagrams of a filter unit, according to an exemplary embodiment of the present disclosure.

FIG. 4 illustrates dynamic characteristics according to a value of the bandwidth gain constant K, and FIG. 5 illustrates rejection performance according to a value of the bandwidth gain constant K. The bandwidth gain constant K may be variable to various values including a first value, a second value, and a third value (K₁>K₂>K₃).

Referring to FIG. 4, when the value of the bandwidth gain constant K is largest (K=K₁), response speed is fastest, and when the value of the bandwidth gain constant K is smallest (K=K₃), response speed is slowest, so it can be confirmed that dynamic characteristics of the filter unit 200 improve as the bandwidth gain constant K has a larger value.

In addition, referring to FIG. 5, it may be confirmed that when the value of the bandwidth gain constant K is largest (K=K₁), rejection performance is lowest, and when the value of the bandwidth gain constant K is smallest (K=K₃), rejection performance is most excellent.

The filter unit 200, according to an exemplary embodiment, may be configured to adjust dynamic characteristics and rejection performance by adjusting the value of the bandwidth gain constant K according to the angular velocity by utilizing the present point. More specifically, the filter unit 200 may be configured to improve rejection performance by applying a low value as the value of the bandwidth gain constant K in a low-speed region where an amplitude of the pulsation component is large, and may improve dynamic performance by applying a high value as the value of the bandwidth gain constant K in a high-speed region where a frequency of the pulsation component is large. Through the present, in a low-speed region where the angular velocity is low, stability of control may be improved, and in a high-speed region where the angular velocity is high, reduction of durability may be mitigated.

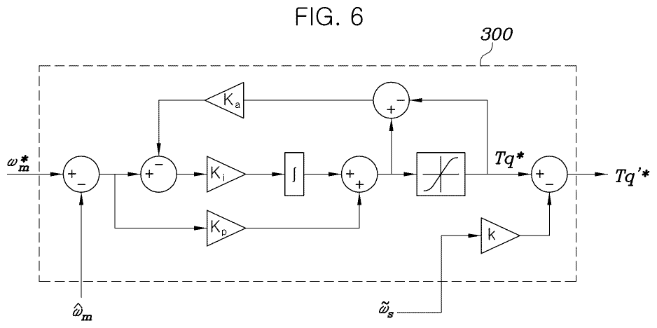

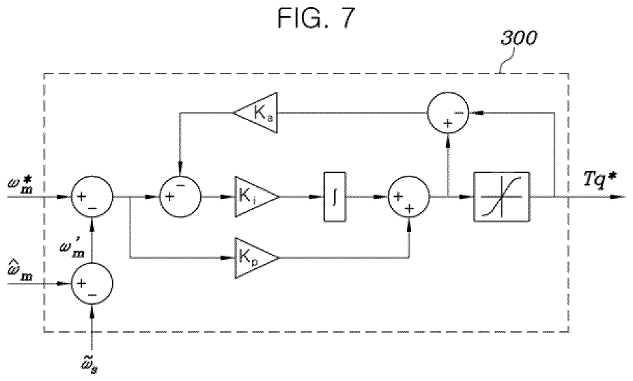

Hereinafter, damping control of the control unit, according to an exemplary embodiment, will be described with reference to FIGS. 6 and 7.

FIGS. 6 and 7 are views illustrating a structure of a control unit, according to an exemplary embodiment of the present disclosure.

First, referring to FIG. 6, a damping control method when the input signal of the filter unit 200 is the torque command

$${T}_{q}^{*}$$

is illustrated.

The control unit 300 may be configured to perform speed control to generate a torque command

$${T}_{q}^{*}$$

based on a target speed

$${ω}_{m}^{*}$$

of the motor 30 and the mechanical angular velocity ωₘ estimated by the estimation unit 100.

More specifically, speed control may be performed such that an error between the target speed

$${ω}_{m}^{*}$$

and the command chama angular velocity \hat{ω}ₘ becomes small. To the present end, the control unit 300 can generate an error between the target speed

$${ω}_{m}^{*}$$

and the estimated mechanical angular velocity \hat{ω}ₘ, and can compensate the generated error through proportional-integral (PI) control. In addition, the control unit 300 may be configured to prevent excessive accumulation of the error through anti-windup control, and may be configured to control an output range of the torque command

$${T}_{q}^{*}$$

within a safe range by limiting a magnitude of an output signal.

Meanwhile, according an exemplary embodiment, the control unit 300 may be configured to perform damping control by removing a pulsation component \tilde{ω}ₛ from the torque command

$${T}_{q}^{*}$$

generated as above to generate a compensated torque command

$${{T}^{′}}_{q}^{*} .$$

In the present case, the control unit 300 may be configured to generate the compensated torque command

$${{T}^{′}}_{q}^{*}$$

by applying a torque compensation gain constant k to the pulsation component \tilde{ω}ₛ, and the torque compensation gain constant k may be determined through experimental results on a damping effect according to the pulsation component \tilde{ω}ₛ and the torque command

$${T}_{q}^{*} .$$

Thereafter, the control unit 300 may be configured to perform current control based on the compensated torque command

$${{T}^{′}}_{q}^{*}$$

from which the pulsation component \tilde{ω}ₛ is removed, and accordingly, vibration generated during driving of the motor 30 can be reduced.

Meanwhile, referring to FIG. 7, a damping control method when the input signal of the filter unit 200 is the mechanical angular velocity \hat{ω}ₘ is illustrated.

In the present case, the control unit 300 may be configured to perform speed control to generate a torque command

$${T}_{q}^{*}$$

based on the target speed

$${ω}_{m}^{*}$$

of the motor 30 and the mechanical angular velocity \hat{ω}ₘ estimated by the estimation unit 100 as in FIG. 6, but may utilize a compensated angular velocity

$${ω}_{m}^{′}$$

obtained by removing a pulsation component \tilde{ω}ₛ from the estimated mechanical angular velocity \hat{ω}ₘ instead of the estimated mechanical angular velocity \hat{ω}ₘ as a feedback signal for speed control. That is, the control unit 300 may be configured to perform damping control by compensating the mechanical angular velocity \hat{ω}ₘ that is input for speed control, instead of compensating the torque command

$${T}_{q}^{*}$$

that is output through speed control as in FIG. 6.

In the present case, speed control itself may be performed in the same manner as in FIG. 6, but because the pulsation component \tilde{ω}ₛ is already reflected, vibration generated during driving of the motor 30 may be reduced even when current control is performed without separately compensating the torque command

$${T}_{q}^{*}$$

that is output as a result of speed control.

Meanwhile, the motor control system 10, according to an exemplary embodiment, may be configured to select a method of damping control according to a magnitude of the angular velocity. That is, according to an exemplary embodiment, after extracting the pulsation component from the torque command according to the magnitude of the angular velocity, a method of compensating the torque command through the extracted pulsation component, or after extracting the pulsation component from the angular velocity, a method of compensating the feedback angular velocity through the extracted pulsation component may be selectively applied. Detailed contents regarding the present will be described together with a motor control method according to an embodiment.

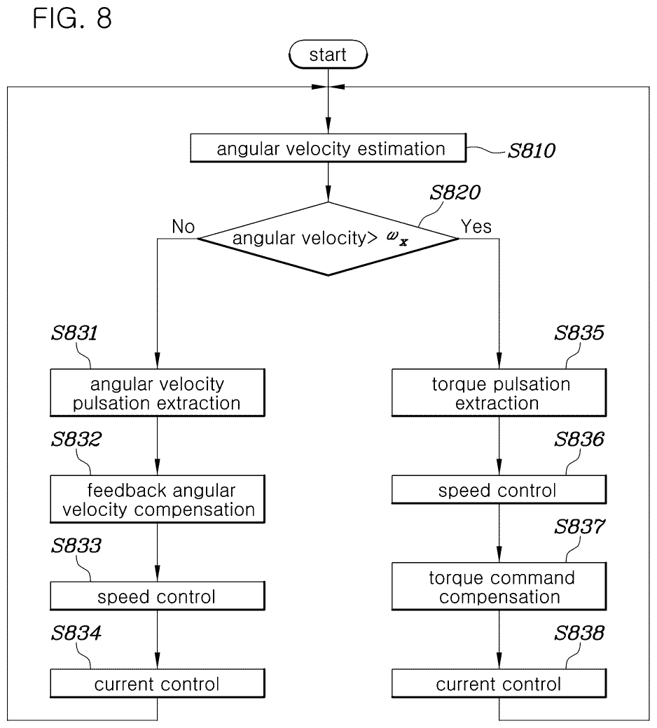

FIG. 8 illustrates a flowchart for explaining a motor control method, according to an exemplary embodiment of the present disclosure.

Referring to FIG. 8, first, the estimation unit 100 may be configured to estimate a mechanical angular velocity of the motor 30 through the above-described extended back EMF based sensorless algorithm in step S810.

The filter unit 200 may be configured to compare the angular velocity with a reference speed in step S820, and may determine an input signal according to a result thereof. Here, the reference speed may be predetermined as, for example, an angular velocity corresponding to a middle value of an entire drive region of the motor 30, and can be a reference for distinguishing a low-speed drive region and a high-speed drive region of the motor 30.

When the estimated mechanical angular velocity is equal to or less than the predetermined reference speed (No in step S820), the filter unit 200 may be configured to extract a pulsation component from the angular velocity using the angular velocity as an input signal in step S831. In the present case, the control unit 300 may be configured to generate a compensated angular velocity by removing the extracted pulsation component from the estimated mechanical angular velocity in step S832, and may be configured to generate a torque command by utilizing the compensated angular velocity for feedback of speed control in step S833.

Thereafter, the control unit 300 may be configured to perform current control based on the torque command generated as a result of speed control in step S834, and thereby vibration generated during driving of the motor 30 may be dampened.

On the other hand, when the estimated mechanical angular velocity exceeds the predetermined reference speed (Yes in step S820), the filter unit 200 may be configured to extract a pulsation component from the torque command using the torque command as an input signal in step S835. In the present case, the control unit 300 may be configured to generate a torque command by utilizing the estimated mechanical angular velocity for feedback of speed control in step S836, and after compensating the torque command by removing the pulsation component from the torque command generated as a result of speed control in step S837, perform current control based on the compensated torque command in step S838, and thereby vibration generated during driving of the motor 30 may be dampened.

Meanwhile, applying different methods of pulsation extraction and damping control in the low-speed region and in the high-speed region as above considers characteristics of pulsation extraction according to a magnitude of the angular velocity. More specifically, the pulsation component extracted from the angular velocity has less phase delay compared to the pulsation component extracted from the torque command, and has a larger magnitude, so it can be more advantageous for pulsation component extraction and damping control based on the extracted pulsation component. However, when extracting the pulsation component from the angular velocity, as the magnitude of the angular velocity becomes larger, it becomes more difficult to extract an accurate amplitude and phase, so it can become more disadvantageous for damping control in the high-speed region.

Therefore, when damping control is performed based on the pulsation component of the angular velocity in the low-speed region and damping control is performed based on the pulsation component of the torque command in the high-speed region as in an embodiment, damping control can be performed in a more advantageous manner in the low-speed and high-speed regions, respectively.

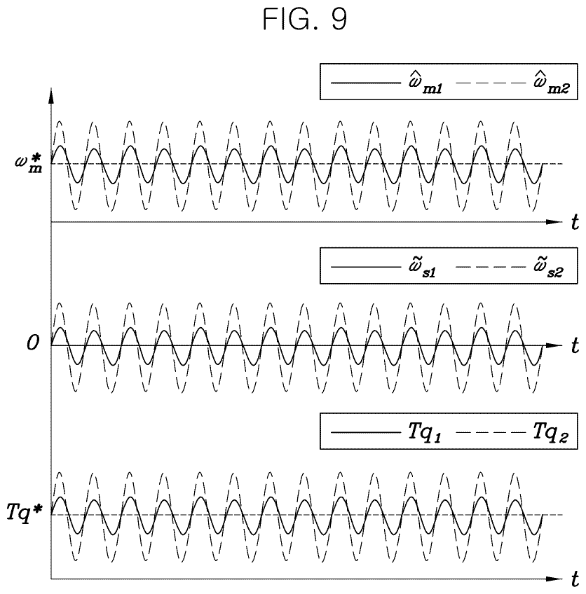

An effect of damping control by the motor control system and control method described so far will be described with reference to FIG. 9 below.

FIG. 9 illustrates a view for explaining an effect of damping control, according to an exemplary embodiment of the present disclosure.

Referring to FIG. 9, aspects of mechanical angular velocity, pulsation component, and torque are illustrated in each of a case where damping control, according to an exemplary embodiment, may be performed and a comparative example in which damping control is not performed, and it may be confirmed that amplitudes of mechanical angular velocity \hat{ω}ₘ₁, pulsation component \tilde{ω}ₛ₁, and torque T_{q1} are each reduced compared to mechanical angular velocity \hat{ω}ₘ₂, pulsation component \tilde{ω}ₛ₂, and torque T_{q2} of the case where damping control is not performed in the case where damping control is performed.

As such, according to various embodiments of the present disclosure as described above, performance of extracting the pulsation component of the motor can be improved through an adaptive filter structure, and control stability and durability of the motor may be improved by performing damping control based on the extracted pulsation component.

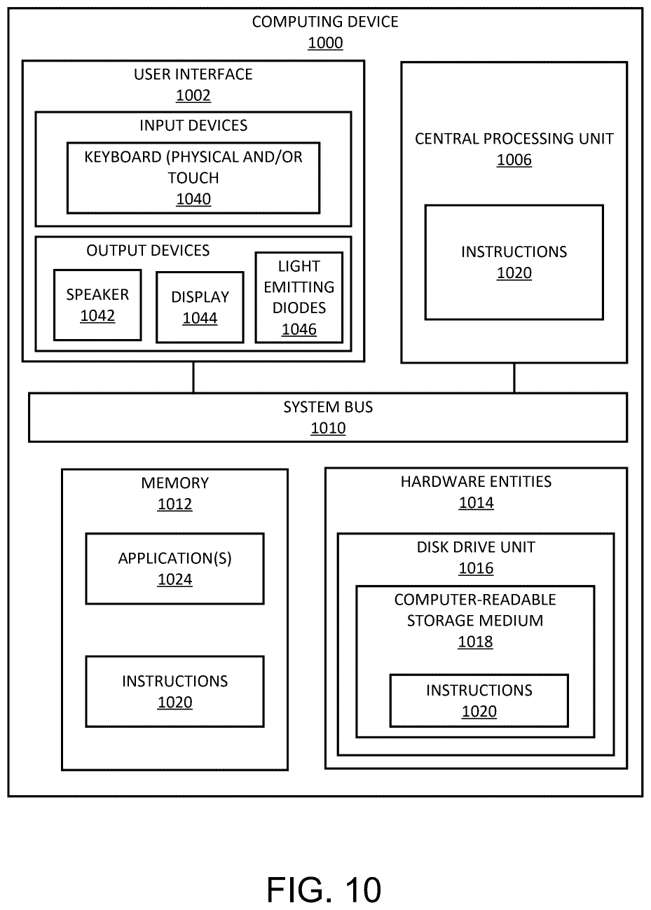

Referring now to FIG. 10, an illustration of an example architecture for a computing device 1000 is provided. According to an exemplary embodiment, one or more functions of the present disclosure may be implemented by a computing device such as, e.g., computing device 1000 or a computing device similar to computing device 1000. Computing device 1000 may be a quantum computer, a classical computer, and/or have one or more components configured to perform one or more quantum and/or classical computing functions. The motor control system 10, the estimation unit 100, the filter unit 200, and/or the control unit 300 may be an example of computing device 1000 and/or may comprise one or more components of computing device 1000.

The hardware architecture of FIG. 10 represents one example implementation of a representative computing device configured to implement at least a portion of the systems/devices and method(s)/control logic(s) described herein.

Some or all components of the computing device 1000 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to, and/or programmed to perform one or more of the methodologies, procedures, or functions described herein.

As shown in FIG. 10, the computing device 1000 may comprise a user interface 1002 (e.g., a graphical user interface), a Central Processing Unit (“CPU”) 1006, a system bus 1010, a memory 1012 connected to and accessible by other portions of computing device 1000 through system bus 1010, and hardware entities 1014 connected to system bus 1010. The user interface may comprise input devices and output devices, which may be configured to facilitate user-software interactions for controlling operations of the computing device 1000. The input devices may comprise, but are not limited to, a physical and/or touch keyboard 1040. The input devices may be connected to the computing device 1000 via a wired or wireless connection (e.g., a Bluetooth® connection). The output devices may comprise, but are not limited to, a speaker 1042, a display 1044, and/or light emitting diodes 1046.

At least some of the hardware entities 1014 may be configured to perform actions involving access to and use of memory 1012, which may be a Random Access Memory (RAM), a disk driver and/or a Compact Disc Read Only Memory (CD-ROM), among other suitable memory types. Hardware entities 1014 may comprise a disk drive unit 1016 comprising a computer-readable storage medium 1018 on which may be stored one or more sets of instructions 1020 (e.g., programming instructions such as, but not limited to, software code) configured to implement one or more of the methodologies, procedures, or functions described herein. The instructions 1020 may also reside, completely or at least partially, within the memory 1012 and/or within the CPU 1006 during execution thereof by the computing device 1000.

The memory 1012 and the CPU 1006 may also constitute machine-readable media. The term “machine-readable media”, as used here, refers to a single medium or multiple media (e.g., a centralized or distributed database, and/or associated caches and servers) that store the one or more sets of instructions 1020. The term “machine-readable media”, as used here, also refers to any medium that is capable of storing, encoding, or carrying a set of instructions 1020 for execution by the computing device 1000 and that cause the computing device 1000 to perform any one or more of the methodologies of the present disclosure. According to various embodiments, one or more computer applications 1024 may be stored on the memory 1012.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

Although shown and described in relation to specific embodiments of the present disclosure as described above, it will be apparent to those skilled in the art that various improvements and changes can be made to the present disclosure within a scope that does not deviate from the technical idea of the present disclosure provided by the following claims.

What is claimed is:

1. A motor control system comprising:
a computing device, comprising a processor and memory, configured to:
estimate an angular velocity of a motor in real time based on a phase current and a voltage command of the motor;
using at least one of a torque command and the angular velocity of the motor as an input signal, extract a pulsation component corresponding to a reference frequency from the input signal;
adjust the reference frequency based on the angular velocity estimated in real time; and
perform damping control to reduce the extracted pulsation component by controlling the motor based on the extracted pulsation component.

2. The motor control system of claim 1, wherein the computing device is configured to extract an output signal having an identical phase to the input signal and having a frequency corresponding to the reference frequency as the pulsation component.

3. The motor control system of claim 2, wherein the computing device is configured to:
generate a delayed signal having a phase delayed by 90 degrees from the input signal; and
feedback control the output signal based on the delayed signal.

4. The motor control system of claim 2, wherein the computing device is configured to feedback control the output signal based on an error signal obtained by applying a predetermined proportional constant to an error between the input signal and the output signal.

5. The motor control system of claim 4, wherein the predetermined proportional constant:
is variable based on the angular velocity, and
is predetermined to have a positive correlation with the angular velocity.

6. The motor control system of claim 1, wherein the computing device is configured to perform the damping control based on a compensated torque command obtained by removing the extracted pulsation component from the torque command, when the input signal is the torque command.

7. The motor control system of claim 1, wherein the computing device is configured to perform the damping control based on a compensated angular velocity obtained by removing the extracted pulsation component from the angular velocity, when the input signal is the angular velocity.

8. The motor control system of claim 1, wherein the computing device is configured to extract the pulsation component from the torque command or extract the pulsation component from the angular velocity based on a magnitude of the angular velocity.

9. The motor control system of claim 8, wherein the computing device is configured to:
extract the pulsation component from the angular velocity when the angular velocity is equal to or less than a predetermined reference speed; and
extract the pulsation component from the torque command when the angular velocity exceeds the reference speed.

10. The motor control system of claim 9, wherein the computing device is configured to:
perform the damping control based on a compensated angular velocity obtained by removing the extracted pulsation component from the angular velocity when the angular velocity is equal to or less than the reference speed; and
perform the damping control based on a compensated torque command obtained by removing the extracted pulsation component from the torque command when the angular velocity exceeds the reference speed.

11. A motor control method comprising:
using a computing device:
estimating an angular velocity of a motor, in real time, based on a phase current and a voltage command of the motor;
extracting a pulsation component corresponding to a reference frequency from an input signal,
wherein the input signal comprises at least one of a torque command and the angular velocity of the motor; and
performing damping control to reduce the extracted pulsation component by controlling the motor based on the extracted pulsation component,
wherein the extracting comprises adjusting the reference frequency based on the angular velocity estimated in real time.

12. The motor control method of claim 11, wherein the extracting comprises extracting an output signal having:
an identical phase to the input signal; and
a frequency corresponding to the reference frequency as the pulsation component.

13. The motor control method of claim 12, wherein the extracting comprises:
generating a delayed signal having a phase delayed by 90 degrees from the input signal; and
feedback controlling the output signal based on the delayed signal.

14. The motor control method of claim 12, wherein the extracting comprises feedback controlling the output signal based on an error signal obtained by applying a predetermined proportional constant to an error between the input signal and the output signal.

15. The motor control method of claim 14, wherein the predetermined proportional constant is variable based on the angular velocity and is predetermined to have a positive correlation with the angular velocity.

16. The motor control method of claim 11, wherein the performing the damping control comprises performing the damping control based on a compensated torque command obtained by removing the extracted pulsation component from the torque command, when the input signal is the torque command.

17. The motor control method of claim 11, wherein the performing the damping control comprises performing the damping control based on a compensated angular velocity obtained by removing the extracted pulsation component from the angular velocity, when the input signal is the angular velocity.

18. The motor control method of claim 11, wherein the extracting comprises:
extracting the pulsation component from the torque command; or
extracting the pulsation component from the angular velocity based on a magnitude of the angular velocity.

19. The motor control method of claim 18, wherein the extracting comprises:
extracting the pulsation component from the angular velocity when the angular velocity is equal to or less than a predetermined reference speed; and
extracting the pulsation component from the torque command when the angular velocity exceeds the reference speed.

20. The motor control method of claim 19, wherein the performing the damping control comprises:
performing the damping control based on a compensated angular velocity obtained by removing the extracted pulsation component from the angular velocity, when the angular velocity is equal to or less than the reference speed; and
performing the damping control based on a compensated torque command obtained by removing the extracted pulsation component from the torque command, when the angular velocity exceeds the reference speed.
